(19) United States
(12) Patent Application Publication
(10) Pub. No.: US 2012/0229595 A1
(43) Pub. Date: Sep. 13, 2012

(54) SYNTHESIZED SPATIAL PANORAMIC MULTI-VIEW IMAGING

(76) Inventor: MICHAEL L. MILLER, Santa Cruz, CA (US)

(21) Appl. No.: 13/045,526

(22) Filed: Mar. 11, 2011

(51) Int. Cl. H04N 13/02; H04N 7/00

(52) U.S. Cl. 348/36; 348/43; 348/E07.001; 348/E13.074

(57) ABSTRACT

Pictures or video images are generated with a synthesized multi-view array of spatial three-dimensional or stereoscopic viewpoints. These images are generated from a two-dimensional monocular digital video signal to be viewed on an autostereoscopic three-dimensional multi-view display that does not require occluding viewing glasses.

### BACKGROUND

### Field of the Invention

The present invention generally relates to three-dimensional (herinafter, “3D”) electronic display of video streams and specifically to the conversion or synthesis of a two-dimensional (hereinafter, “2D”) monocular digital video to spatial multi-view array 3D autostereoscopic display systems.

As three-dimensional displays, 3D TV's, move from vertical visualization markets to mass merchandiser consumer entertainment markets following the explosive growth of the 3D cinema there is a need for new 3D display solutions. Two of the problems that may limit growth in this area are the need to eliminate the viewing glasses and the lack of sufficient 3D spatial video content. What are needed are ways of conversion or synthesis of 2D monocular digital video to a spatial multi-view array format used 3D autostereoscopic spatial display systems. These would solve both problems for the emerging home and mobile consumer markets as consumers could have much more available 3D programming than what is currently developed by 3D technology.

Autostereoscopic spatial display systems have an added advantage by eliminating the need for expensive active glasses or passive glasses that limits vertical resolution. Autostereoscopic spatial display systems should allow a look around, panoramic, capability of objects or subjects of the converted 3D spatial multi-view content results. What is needed are systems that provide better vertical resolution as well as panoramic capabilities.

Motivation for 3D is somewhat slowed in the consumer markets because there is a limited amount of 3D stereoscopic content for muti-view displays. However a consumer desire for s 3D viewing especially for certain subjects or applications like 3D video games, music videos or spectator sports where 3D spatial viewing adds great value. What is needed are new market cycles for content providers or distribution channels of 3D content.

### SUMMARY

The present invention discloses a system and method for synthesizing 3D panoramic array of multi-view spatial three-dimensional viewpoints for an autostereoscopic spatial display from a single two-dimensional monocular source digital video media signal. This includes the operations of storing digital video image frames from the single two-dimensional monocular source digital video media signal sequentially into a digital buffer memory frames, temporally copying the source frame sequence to a storage buffer, altering the copy frame sequence order with an incrementally progressive moving subset copy order into the copy frame sequence, the moving subset with a pre-selected constant maximum size constant M, incrementally dropping the head subset member and adding the next sequential tail member for each incremental subset pass cycle copy from the source copy.

Furthermore the process includes vertical-interleaving a multi-view frame from M sequential temporal frames by copying column of pixels from each of the M subset frames to each multi-view frame starting with copying the first vertical pixel column of each sequential M frame to the multi-view frame positioning the M columns sequentially in the multi-view frame, progressively copying the next Nth vertical pixel column from each of the M frame subset to the multi-view frame until each Nth vertical column from each of the M frame set frames has been copied and sequentially stacked by M sequence order in adjacent vertical columns in the multi-view frame, incrementing the M sequential subset start frame by one and synthesizing the next sequential multi-view frame until the frame sequence moving M frame subset exhausts the available unprocessed temporal source frame copy, and thereby creating a multi-view panoramic array of multi-view digital video image frame sequence for 3D viewing on a barrier or lenticular screen display.

Additionally the moving subset maximum size constant M is programmably changeable on the fly from 4 through 9, which extends from four to nine views in the same sequence pattern allowing for more horizontal viewing zones and viewing angles. This and other on the fly adjustable parameters in the conversion process allow for a user selectable remote control experience.

These and other user 3D selectable parameters for the 3D functions are then embedded into remote control devices and interfaces to provide user control over subjective and personal 3D experience for the synthesized 3D video.

### BRIEF DESCRIPTION OF DRAWINGS

Specific embodiments of the invention will be described in detail with reference to the following figures.

FIG. 1 is a frame block diagram illustrating the streams of input and output frame structure in accordance with an embodiment of the invention.

FIG. 2 is a frame block diagram illustrating the streams of input and output frame structure and sequence in accordance with an embodiment of the invention.

FIG. 3 is a frame block diagram illustrating the frame mask mechanism for detection and velocity of relative horizontal motion in accordance with an embodiment of the invention.

FIG. 4 is a simple pictorial diagram illustrating the multi-view frame Positive-Negative Parallax extensions from the plane of convergence applied with converted 3D video content for a multi-view video display in accordance with an embodiment of the invention.

FIG. 5 is a frame block diagram illustrating the multi-view frame horizontal parallax adjustment in accordance with an embodiment of the invention.

FIG. 6 is a simple pictorial illustrating the 3D remote adjustment functions in accordance with an embodiment of the invention.

FIG. 7 is a schematic diagram of a computer that may implement one, several or all of the aspects of the method of the present invention.

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### OBJECTS AND ADVANTAGES

The present invention discloses a system and methods of converting legacy 2D to 3D electronic display of pictures and video streams. Embodiments of the invention will enable a conversion or synthesis of 2D monocular digital video to a spatial multi-view array format used by next generation 3D, without glasses, autostereoscopic spatial display systems for the emerging home and mobile consumer markets

Accordingly, it is an object of the present invention to provide ways to generate 3D images from new or legacy 2D images and image streams.

It is another object of the invention to process 2D images and image streams and convert to 3D images and images streams in near real-time.

It is yet another object of the present invention to provide embodiments designed for on the fly adjustment of 3D images to accommodate the various subjective preferences of viewers to individually adjust a 3D presentation which best accommodates their personal viewing profile and subjective viewing experience. This made possible through placing or embedding the 3D adjustment functions in remote control devices.

Yet another objective is to move away from just a stereoscopic view to conversion to a multi-view format with 4 to 9 viewpoints for the next generation of autostereoscopic displays.

The current stereoscopic pair methods limit the 3D technology to one image pairs, so another objective is to allow for spatial viewpoints which provide multi-view zones and hence subjective customized adjustment of 3D experience richer format.

It is another object of the invention to create a user customizable 3D experience by embedding the 3D adjustable 3D functions into a user remote and interface.

### FIGURES DESCRIBING EMBODIMENTS OF THE INVENTION

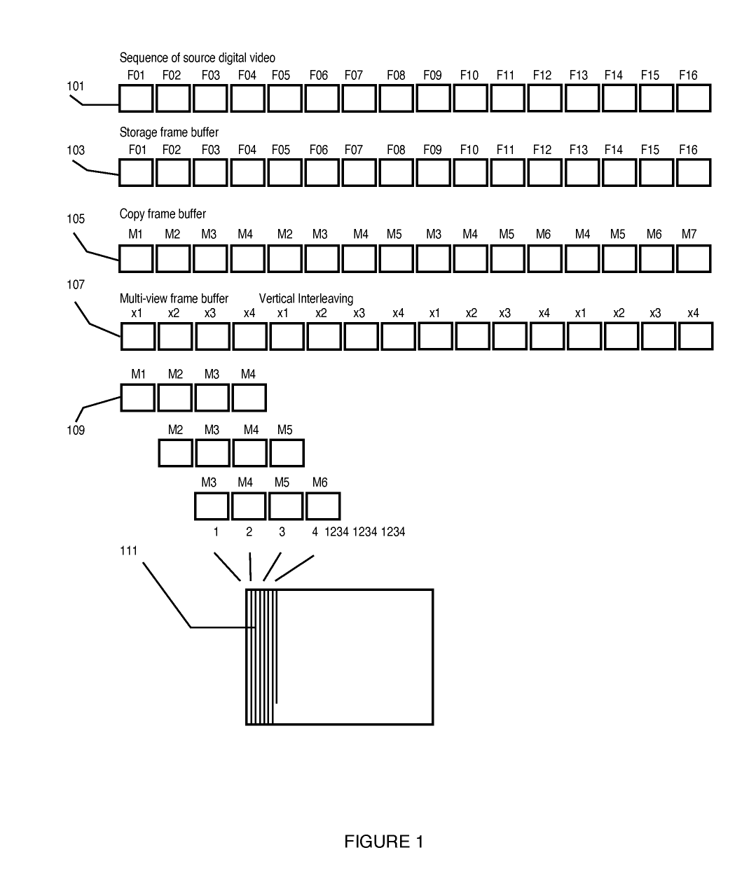

FIG. 1 is a frame block diagram illustrating the streams of input and output frame structure in accordance with an embodiment of the invention. We begin capturing 3D spatial multi-view structure from 2D motion by using horizontal digital frame offset and frame delay to convert temporal 2D media to a sequence of horizontal digital frames or by creating a panoramic array sequence of horizontal viewing multi-view zones. These create a vertical interleaving sequence incorporated in an autostereoscopic lens or barrier spatial display for viewing a 3D stereo compression space using frame offset and/or controlled frame delay sequence method.

In a preferred embodiment the source single two-dimensional monocular digital video signal used by the process is refreshed at 30 hz to 240 hz digital, typically 120 hz. A continuing sequence stereo left and right stereoscopic digital frames are extracted in real time by using alternating digital frames of the source single two-dimensional monocular digital video signal and formatted into a spatial multi-view format.

This process proceeds by acquiring first frame 01, from a sequence of source digital video 101, storing first frame 01 in a storage frame buffer 103; copying frame 01 to a copy frame buffer 105; acquiring second frame 02, storing second frame 02 in the storage frame buffer 103; copying frame 02 to the copy frame buffer 105; acquiring third frame 03, storing third frame 03 in the storage frame buffer; copying frame 03 to the copy frame buffer; acquiring fourth frame 04, storing fourth frame 04 in the storage frame buffer; copying frame 04 to the copy frame buffer; acquiring fifth frame 05, storing fifth frame 05 in the storage frame buffer, applying multi-view spatial offsets 111 to a moving subset of in this instance 4 frames M1, M2, M3, M4 109 for multi-view display 107; copying frame 05 to the copy frame buffer; acquiring sixth frame 06, storing sixth frame 06 in the storage frame buffer, applying multi-view spatial offsets to the moving subset of 4 frames M2, M3, M4, M5 110 which are moving because they have dropped the 1^{st} member M1 and taken on a new tail member M5 for multi-view display; copying frame 06 to the copy frame buffer; acquiring seventh frame 07, storing seventh frame 07 in the storage frame buffer, applying multi-view spatial offsets to the next moving subset of frames M3, M4, M5, M6 for multi-view display; copying frame 07 to the copy frame buffer; acquiring eighth frame 08, storing eighth frame 08 in the storage frame buffer, applying multi-view spatial offsets to the next moving subset of frames M4, M5, M6, M7 for multi-view display; copying frame 08 to the copy frame buffer; and so on so forth.

This four view process can be extended from five to nine members by increasing the moving subset from five to nine views in the same sequence pattern allowing for more horizontal viewing zones.

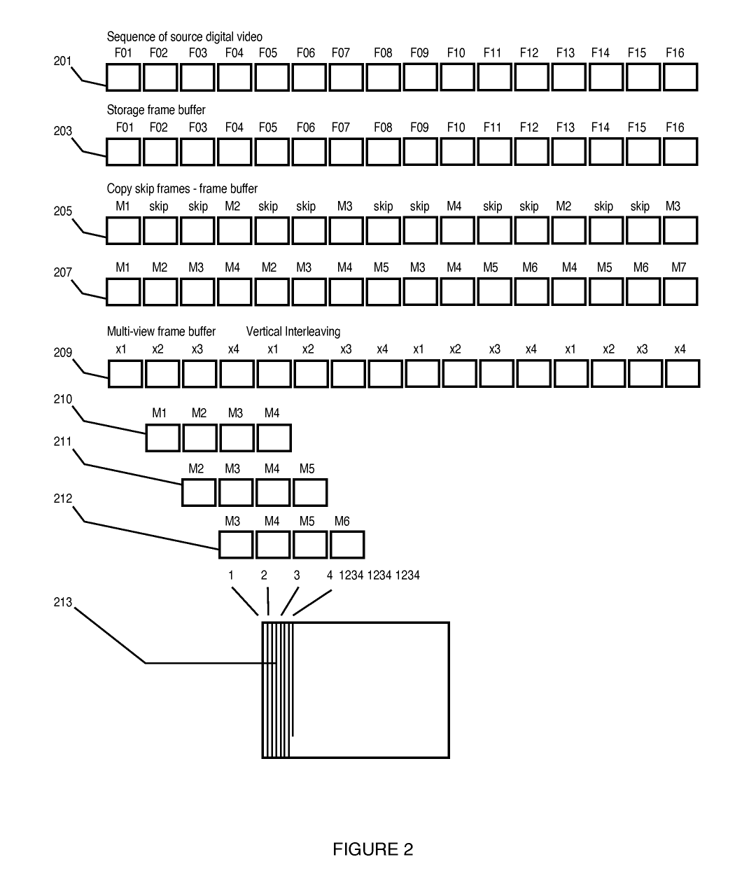

FIG. 2 is a frame block diagram illustrating the streams of input and output digital image frame structures and sequences with skip frames in accordance with an embodiment of the invention. Rapidly moving screen artifacts can destabilize the phase, reversal of the stereoscopic pairs, and can thus be controlled with the introduction of skip frames 205. This embodiment threads much like the previous embodiment but with the inclusion of skip frames 205, which are added after each source frame copy 203 from the source frame sequence 201 to slow faster moving objects across the display by introducing a form of time delay.

A received source of digital video frames 201 are stored as digital video image frames 203 from the single two-dimensional monocular source 201 digital video media signal sequentially into a digital buffer memory frames 203. These are copied to temporary storage altering the copy frame sequence with a pre-determined number of skip frames 205, and re-labeled in the order with an incrementally progressive moving subset copy order 210 211 213 into the copy frame sequence 207, the moving subset with maximum size constant M, incrementally dropping the head subset member and adding the next sequential tail member for each incremental subset pass cycle copy from the source frame copy 203.

One or more shift frames can be added after each source frame. The number of shift frames added per source frame will depend on the velocity of objects in the frame. The velocity of moving objects in the horizontal direction is determined by comparing the objects pattern positions in consecutive source frames. High velocity objects in frames produce pronounced self-adjusting disparity or parallax. Frames with high velocity moving object must then be controlled by delays from the added shift frames. An embodiment of the invention introduces shift frames which can then be used to control the disparity. Controlling the number of shift frames dynamically and programmatically in relation to object velocity controls the affect of fast moving objects on the 3D screen by maintaining stereoscopic synchronicity.

A vertical-interleaving a multi-view frame 213 from M sequential temporal frames is obtained by copying column of pixels from each of the M frames 210 211 212 to each multi-view frame 213 starting with copying the first vertical pixel column of each sequential M frame 210 211 212 to the multi-view frame 213 positioning the M columns sequentially in the multi-view frame 213, progressively copying the next Mth vertical pixel column from each of the M frame 210 211 212 set to the multi-view frame 213 until each Mth vertical column from each of the M frame set frames 210 211 212 has been copied and sequentially stacked by M sequence order in adjacent vertical columns in the multi-view frame 213.

Incrementing the M sequential set start frame by one and synthesizing the next sequential multi-view frame until the frame sequence moving M frame set exhausts the available unprocessed temporal source frame copy, thereby creating a multi-view panoramic array of multi-view digital video image frame sequence for 3D viewing on a barrier or lenticular screen display.

Detecting the relative direction of objects and subjects which are perceived by an observer to be moving horizontally across the screen are used to keep the multi-view sequence in phase. Insuring that the right frame and left frame views of any viewing zone within the multi-view array do not reverse. If the left and right view are reversed a motion adaptation switch machine vision method will switch the synthesized spatial multi-view stereo left right pairs of a viewing zone keeping them in phase while the relative direction of the object or subject in the source content moves in the frame, in an arbitrary left to right or right to left direction across the respective key frames. This process will detect a change of the relative horizontal direction of the subject or object in a sequence and trigger a phase reverse switch, thereby keeping the stereo pairs or the right frame and left frame views of any viewing zone within the multi-view array in phase with the start-point of the converted synthetic 3D stereoscopic video results

In another embodiment of the invention, the user can selectively adjust to use a continuing alternating sequence of digital frames from the source single two-dimensional monocular digital video signal. Thus to extract the stereo pairs or skip the next digital frame in the sequence or skip any number of frames in a sequence selected between the key frames, stereoscopic view, these adjustments are user selectable from 1-9 digital frames in a sequence by a handheld remote control or a keyboard. Other control interfaces may be used and include software based graphical user interface control panel selection or by a handheld remote control keyboard selection or by a voice controlled selection or a gesture controlled selection pointing with your hand at a screen menu, graphical user interface selection, by a smart phone or smart tablet touch based remote control app, an automated software based process selection for adjusting the horizontal parallax or disparity of each alternating frame in the multi-view format sequence.

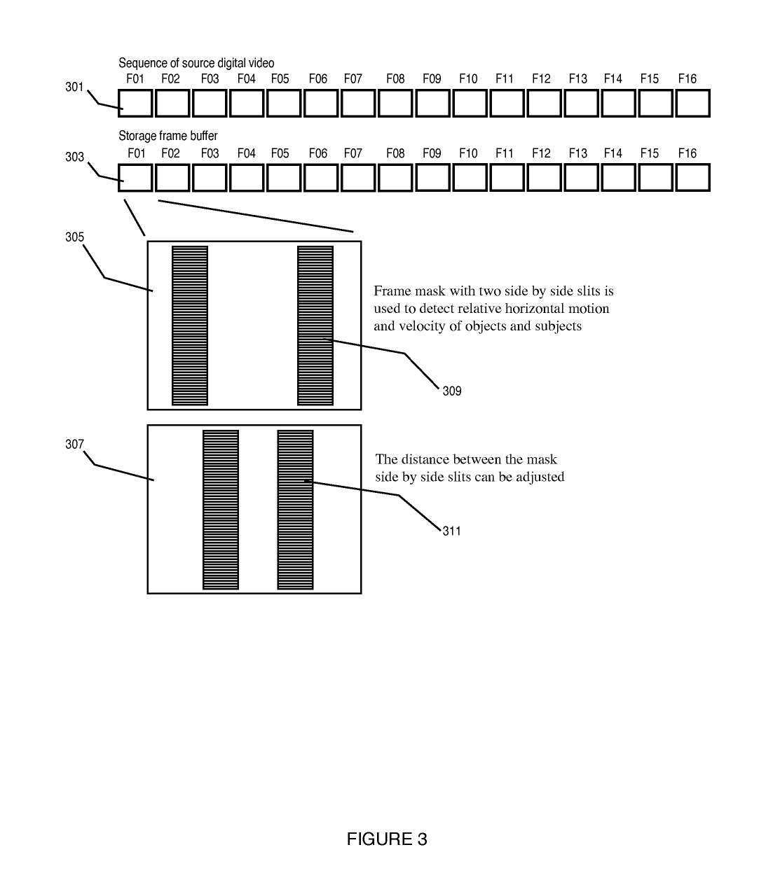

FIG. 3 is a frame block diagram illustrating the frame mask mechanism for detection of relative horizontal motion in accordance with an embodiment of the invention for phase correction.

In another embodiment of the invention a source video frame sequence 301 is stored in storage frame buffer 303 and a machine vision motion adaptation switch maintains the synthetic 3D multi-view views in phase. An invention embodiment uses an method that compares two masked horizontal side by side vertical stripe segments 309 in a frame 305, the distance between the masked strips is adjustable, in each frame 305 307 in the sequence of the source single two-dimensional monocular digital video signal frames 303. The patterns of the sequence of digital frame strips 309 are processed to determine the relative direction of a pattern representative of the relative direction of objects or subjects in the frame, left to right or right to left, in the source video frame sequence 301. A detected change then triggers a phase reverse switch, thereby keeping the stereo pairs or the right frame and left frame views of any viewing zone within the multi-view array 305 307 in phase with the start-point of the converted synthetic 3D stereoscopic video results.

The correct parallax can be maintained by the choice of selecting a straight continuing sequence of source frames to extract stereo left right frame pairs or skip to the next frame or a number of frames in the multi-view sequence. The number of frames to be skipped can be user-selected or varied by the relative speed or velocity of objects or subjects moving horizontally across the screen in the source content. The distance between the masked strips can be adjusted in each frame in the sequence of the single two-dimensional monocular digital video signal frames and the patterns of sequence of digital frame strips compared to determine the relative parallax adjustment to have a more consistent conversion or correct parallax regardless of the relative speed or velocity of objects or subjects moving horizontally across the screen.

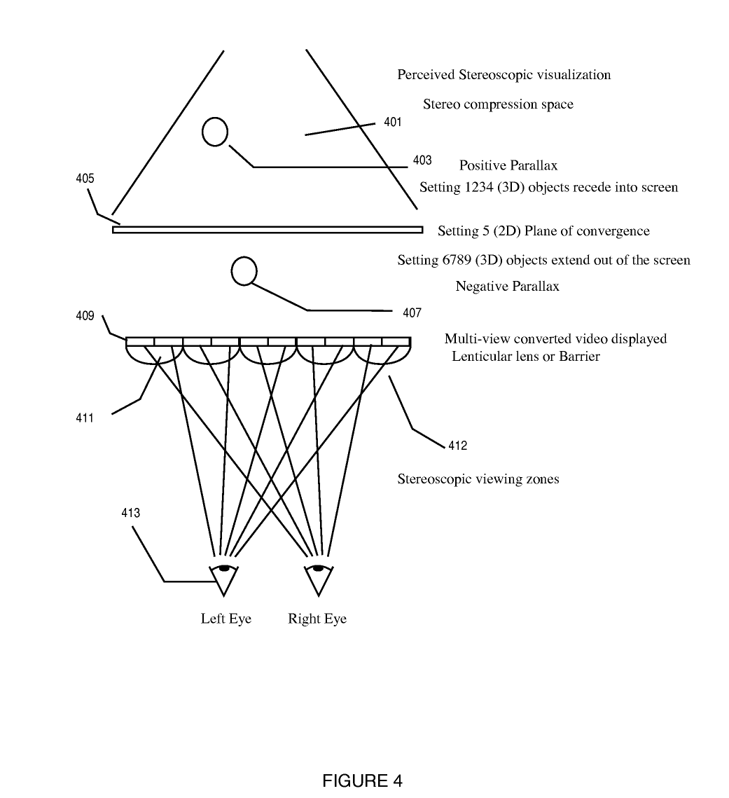

FIG. 4 is a simple pictorial diagram illustrating the multi-view frame positive-negative parallax extensions from the plane of convergence in accordance with an embodiment of the invention. As above, synthetic 3D stereoscopic multi-view viewing zones 412, stereo compression space 401, is adjusted by shifting the horizontal parallax between each alternating frame in the multi-view format sequence from positive parallax, receding to horizon field 403, to negative parallax, objects or subjects 407 extending out of the plane of convergence—the screen plane 405 within the frame of the 3D display 409 superimposed on a stereoscopic viewing zone 411 412. Another embodiment of the invention is provides for a remote user device functions for user selectable parallax, phase changes, 3D test patterns, 3D default settings, and more. This is made possible by programmatically assigning a scale, corresponding to number of positive parallax frames to precede a center plane of convergence frame 403 followed by an equal number of negative parallax frames 407 for the column interleaving resulting in multi-views or multiple stereoscopic pair frames.

The correct disparity or parallax can be maintained by the choice of selecting a straight continuing sequence of frames to extract stereo left right frame pairs for lenticular or barrier display pixel columns 409 and 411 respectively, or skip to the next frame or a number of frames in the multi-view sequence. This could be selected or varied to adjust for the relative speed or velocity of objects or subjects 403 407 moving horizontally across the screen 405, with assigned exemplar values 1-9 to an interactive user. The source content FIG. 3 303 is used for frame pixel compares with a machine vision method to process the two masked horizontal side by side vertical stripe segments 309 311. The distance between the masked strips are software programmatically adjustable by the user on the fly in each frame in the sequence of the single two-dimensional monocular digital video signal frames. The patterns of sequence of digital frame strips are compared to determine the relative parallax adjustment to have a more consistent conversion or correct parallax adjusting for the relative speed or velocity of objects or subjects 403 407 moving horizontally across the screen 405 and received by the right and left eyes 413 in the stereoscopic viewing zones 412.

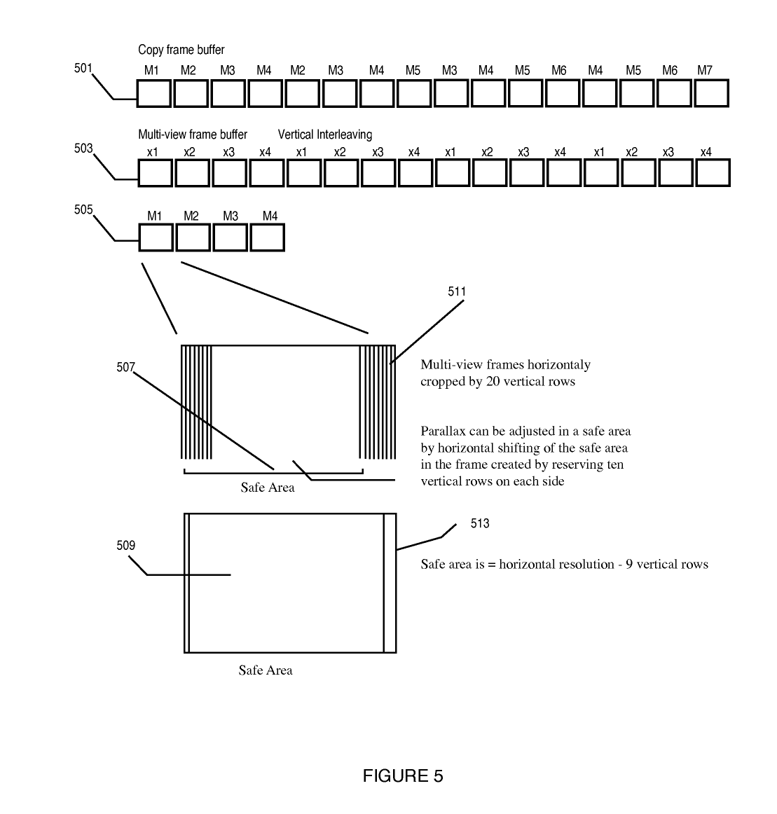

FIG. 5 is a frame block diagram illustrating the multi-view frame horizontal parallax adjustment in accordance with an embodiment of the invention. The copy frame buffer 501 is used in a moving frame subset reordering manner multiplexing to the multi-view frame buffer 503 sequence with vertical interleaving but with the addition of a save area 507 which includes a multi-view frame with horizontally cropped vertical rows at the left and right margins 511 of each frame. In the exemplar, 10 vertical columns are shown on each frame side. The action of horizontally shifting the safe area from frame side to side using the reserved margin vertical rows on each side, changes or adjusts the parallax by changing the position and hence the order of the stereoscopic pairs.

The disparity or parallax of resulting synthetic 3D stereoscopic multi-view viewing zones, stereo compression space, can be can also be adjusted by shifting the horizontal parallax between each alternating frame in the multi-view format sequence from positive parallax, receding to horizon field, to negative parallax, objects or subjects extending out of the plane of convergence—the screen plane within the frame of the 3D display. This can be made user selectable by assigning a scale from for example 1 to 9, positive parallax for subset frames 1234 with 5 as the center plane of convergence and subset frames 6789 negative parallax. The user adjustments within a safe area 507 in the frame buffer are made by subtracting a total of nine vertical lines 511, from either side of the frame buffer, which when done incrementally and programmatically, allows yet another way to control the 3D experience of multi-view. This adjustment can be implemented at the user level with keyboard arrow keys, user selectable scroll bar which correspond to digital frames in a sequence, by a handheld remote control or a keyboard selected by numerical key, software based graphical user interface control panel selection or by a handheld remote, control keyboard selection or by a voice controlled selection or a gesture controlled selection pointing with your hand at a screen menu, graphical user interface selection, by a smart phone or smart tablet touch based, remote control application or by an automated software based process selection. This adjustment of 3D experience can be implemented by almost any existing interface and makes 3D a user not producer function.

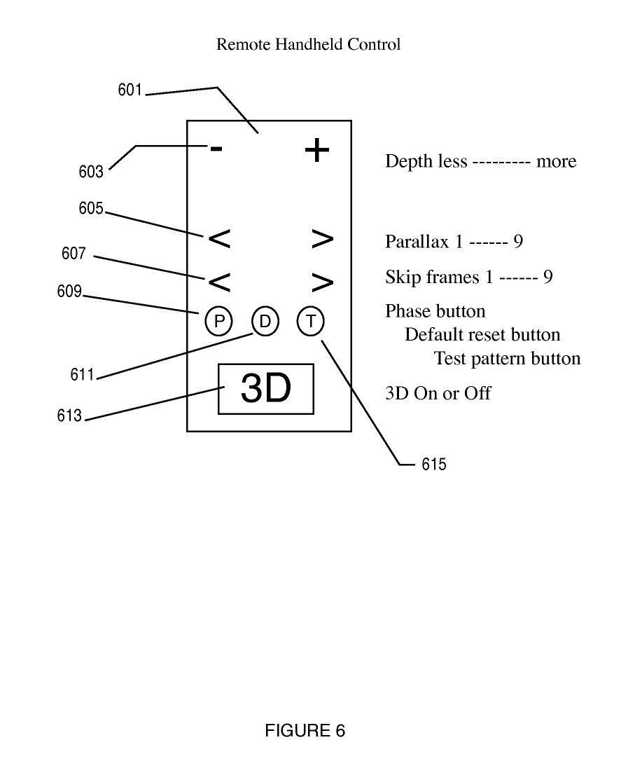

FIG. 6 is a pictorial illustrating the 3D remote control adjustment functions in accordance with an embodiment of the invention.

Since embodiments of the invention are programmable features in the processing and viewing of 3D video content via electronic devices both remotes 601 and processor, the 3D feature can be adapted to be controlled remotely by any number of wireless technologies. The 3D subjective adjustment features include a phase switch 609, default 611, test pattern 615, 3D on, skip frame 607 delay, parallax 605 and or depth 603 of 3D spatial dimension.

In an embodiment of the invention a manual or selectable phase switch 609-L or R selection can be remotely controlled by the user. A software based graphical user interface control panel selection, a handheld remote control device selection, a smart phone or smart tablet touch based remote control application or by voice command selection or by an automated software based process selection can trigger a phase reverse switch, the feature for keeping the stereo pairs, the right frame and left frame views, of any viewing zone within the multi-view array in phase with the start-point of the converted synthetic 3D stereoscopic video results.

In another embodiment of the invention, a manual or selectable default settings from a software based graphical user interface control panel selection or by a handheld remote control device 611 selection or by a smart phone or smart tablet touch based remote control application or by voice command selection or by an automated software based process selection would reset default settings

A manual, 2D or 3D, selectable button 613 or manual keyboard key selection or a handheld remote control device selection or by a smart phone or smart tablet touch based remote control application or by voice command selection or by an automated software based process selection can turn on the described conversion process on or off and bypass the 3D conversion for standard 2D viewing. A manual or selectable menu item can be used in a graphical user interface to select and transcode the 3D display output format used.

A test 3D registration pattern 615 target can be displayed on the screen to enable the viewer to select either (a.) a preferred viewing settings or (b.) a return to the default setting 611. When searching for that optimal 3D viewing, the subjective nature of many of the adjustable parameters may lead the system in a state whose original settings path is lost. Or the system maybe mal adjusted in which case the user would run the 3D test pattern to establish if the original factory test pattern show any problems.

A four view multi-view, or five to nine view multi-view, side by side by side format 1234 2345 3456 4567 is a preferred embodiment multi-view meta format which can be remote selectable function. This simplest multi-view can be the starting point of any further adjustments of spatial depth.

In a process of pixel-math manipulation, the resulting synthesized three-dimensional or stereoscopic or panoramic content results can be numerically scalable for a variety of screen formats and aspect ratios, 4/5 9/16 etc. In some embodiments the platforms from mobile appliances, autostereoscopic smart phone or tablet, autostereoscopic desktop, home flat or projection based displays including LCD or OLED, Mpeg 2-4, 264 compression, 780p, 1080p etc. and other display formats used by autostereoscopic display systems can be adapted for use.

In another embodiment, the process can be implemented on a 3D GPU accelerated PC platform with the ability to convert a digital video signal or web based content for display on a multi-view autostereoscopic, vertical interleaving display driver, display or a 3D laptop with an autostereoscopic display

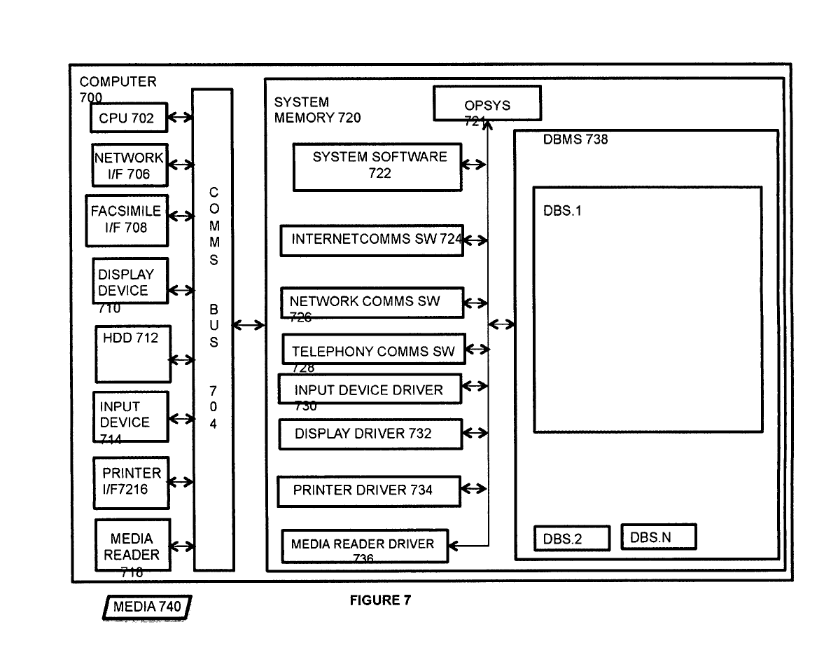

Referring now generally to the Figures and particularly to FIG. 7, FIG. 7 is a schematic diagram of a computer 700 that may implement one, several or all of the aspects of the method of the present invention. The computer 700 includes a processor 702 (hereinafter “CPU” 702) that is bi-directionally communicatively coupled by an internal communications bus 704 with a network interface circuit 706, a tele-facsimile transmission interface circuit 708, a display device 710, a hard disk drive module 712, a user input device 714, a printer interface circuit 716, a media reader module 718 and a system memory 720. It is understood that the CPU 702 may be comprise, or be formed by, a one, two or a plurality of computational logic circuits or devices.

The display device 710 renders visual images according to the aspects of the method of the present invention.

The computer 700 may be or comprise (a.) a network-communications enabled SUN SPARCSERVER™ computer workstation marketed by Sun Microsystems of Santa Clara, Calif. running a UBUNTU™ operating system available from Canonical Group Limited, having offices at 27th Floor, Millbank Tower 21-24 Millbank London SW1P 4QP United Kingdom, a LINUX™ operating system as provided by Red Hat<inc. of Raleigh, N.C., or a UNIX™ operating system as published by AT&T Corporation of Dallas, Tex.; (b.) a network-communications enabled personal computer configured for running WINDOWS XP™, VISTA™ or WINDOWS 7™ operating system marketed by Microsoft Corporation of Redmond, Wash.; (c.) a VAIO FS8900™ notebook computer marketed by Sony Corporation of America, of New York City, N.Y.; (d.) a PowerBook G4™ personal computer as marketed by Apple, Inc. of Cupertino, Calif.; and/or a suitable mobile communications device known in the art, such as an iPhone G4™ as marketed by Apple, Inc. of Cupertino, Calif.

The system memory 720 loads and stores a software operating system “OPSYS” 721, such as a LINUX™ or UNIX™ operating system; a WINDOWS XP™, VISTA™ or WINDOWS 7™ operating system as marketed by Microsoft Corporation of Redmond, Wash.; or a MAC OS X operating system as marketed by Apple, Inc. of Cupertino, Calif. The system memory 720 further loads and stores the system software 722, an Internet software communications program 724, a network communications software 726, a telephony communications software 728, an input device driver 730, a display device driver 732, a printer driver 734, a media driver 736 and a data base management system 738. The database management system DBMS 738 may be or comprise and an object oriented database management system (“OODBMS”) and/or a relational database management system (“RDBMS”), and one or more databases DBS.1-DBS.N. A first database DBS.1 and/or one or more additional databases DBS.2-DBS.N may be or comprise an object-oriented database and/or a relational database.

The display device driver 732 enables or supports the display device 710 to render visual images according to one or more aspects of the method of the present invention.

The network interface circuit 706 in combination with the Internet communications software program 724, the network communications software 726, and/or the telephony communications software 728 enable bi-directional communications of the computer 700 with, or via, the Internet, and a electronics communications network, and/or a telephony network.

The system software 722 includes machine-readable software encoded instructions that direct the computer 700 to create, store, instantiate and/or execute one, a plurality, or all of the records, process steps, and processes disclosed herein.

A tangible electronic media 740 and the media reader module 718 are selected and configured to enable the media reader module 718 to access software encoded information and instructions from the media reader module 718 and for transmission through the communications bus 704 to the CPU 702, the electronic memory 720, and other elements of the computer 700. The electronic media 740 may store a plurality of software encoded records and record types.

It is understood that one or more records or information stored within the first database DBS.1 may be stored as originals or copies in the tangible media 740 or elsewhere within the Internet or other electronic communications network.

Therefore, while the invention has been described with respect to a limited number of embodiments, those skilled in the art, having benefit of this invention, will appreciate that other embodiments can be devised which do not depart from the scope of the invention as disclosed herein. Other aspects of the invention will be apparent from the following description and the appended claims.

What is claimed is:

1. A method for synthesizing 3D panoramic array of multi-view spatial three-dimensional viewpoints for an autostereoscopic spatial display from a single two-dimensional monocular source digital video media signal comprising:
a. storing digital video image frames from the single two-dimensional monocular source digital video media signal sequentially into a digital buffer memory frames;
b. temporally copying the source frame sequence to a storage buffer, altering the copy frame through the addition of frames from an incrementally progressive moving subset into the copy frame sequence, the moving subset with pre-selected constant maximum size M, incrementally dropping the head subset member and adding the next consecutive tail member for each incremental subset copy cycle from the source frame sequence;
c. vertical-interleaving a multi-view frame from M sequential temporal frames, copying one or more columns of pixels from each of the M moving subset frames to each multi-view frame starting with copying the first vertical pixel column of each sequential M frame to the multi-view frame positioning the M columns sequentially in the multi-view frame, progressively copying a preset constant Nth vertical pixel column from each of the M frame subset to the multi-view frame until each Nth vertical column from each of the M frame subset frames has been copied and columns sequentially stacked by M sequence order in adjacent vertical columns in the multi-view frame; and
d. incrementing the M sequential subset start frame by one and synthesizing the next sequential multi-view frame until the frame sequence moving M frame subset exhausts the available temporal source frame sequence, thereby creating a multi-view panoramic array of multi-view digital video image frame sequence for 3D viewing on a barrier or lenticular screen display.

2. The method of claim 1 wherein the moving frame subset maximum size constant M is programmably changeable on the fly from four through nine, which extends from four to nine views respectively in the same sequence pattern allowing for four to nine ordered stereoscopic pairs respectively and as many resulting horizontal viewing zones.

3. The method of claim 1 further comprising altering the frame sequence order by programmatically adding one or more skip frames after each source frame copy to the temporal buffer frame sequence to adjust for stereoscopic pair disparity developed from objects moving across the frame.

4. The method of claim 1 further comprising a 3D visual presentation embedded into and displayed on a 3D autostereoscopic display circuit chosen from a group of 3D autostereoscopic display systems consisting essentially of a TV display system, desktop display system, laptop display system, PDA display system, smart mobile application software system, smart phone display system, handheld tablet display system, projection based display system, 3D enabled PC display system, 3D podcast display system by uploading a 3D podcast from a 3D PC to a 3D display, a set-top box display system, media hub or media server display system, Apple® TV app, Comcast® display system, and head mounted display with a head orientation tracking multi-view look-around capability system.

5. A method for a machine vision motion adaptation switch through detection of the relative direction of objects in synthesized 3D panoramic array of multi-view viewpoints further comprising:
a. reading in single two-dimensional monocular digital video signal frame source;
b. providing two horizontal side by side adjustable width vertical stripe segment digital frame masks with adjustable separation distance in each of two consecutive frames;
c. comparing the masked pixel patterns of the source frame strips to determine the relative left or right direction of a pattern of the relative direction of objects in the frame, left to right or right to left; and
d. triggering a phase reverse switch upon determining a object pattern direction reversal, thereby automatically maintaining the stereo pairs or the right frame and left frame views of any viewing zone within the multi-view array in phase with the start-point of the converted synthetic 3D stereoscopic video display results.

6. A method for adjusting disparity or parallax of synthetic 3D stereoscopic multi-view stereo compression space comprising:
a. storing digital video image frames from the single two-dimensional monocular source digital video media signal sequentially into a digital buffer memory frame sequence;
b. creating a sequence of 3D stereoscopic interleaved column multi-view frames with N view pairs;
c. reserving margins of one or more vertical pixel columns on the left and equal number of vertical pixel columns on the right edges of the interleaved video 3D stereoscopic multi-view frame, shifting the horizontal parallax between each alternating frame in the multi-view format sequence from positive parallax to negative parallax by shifting the number of columns for the start frame; and
d. shifting the start frame column from left to right on demand by a user selectable interface circuit programmably moving the reserved columns midway into the reserved column margin for positive parallax leaving the center column as the center plane of convergence and the remaining columns for negative parallax within a safe area in the frame buffer width calculated by subtracting the frame horizontal resolution of the interleaved frame from one side of reserved margin, whereby user selection on demand programmably changes the interleaving frame buffer shifting the safe area into and out of the reserved margin vertical pixel columns adjusting the parallax of the multi-view frames into and out of the display screen respectively.

7. The method of claim 1 further comprising altering at least programmable parameter in the multi-view digital video image frame process remotely or wirelessly and hence customizing the user 3D experience by a group of 3D viewing functions consisting essentially of 3D default settings, 2D or 3D selection, 3D test registration pattern, altering the number of multi-views per frame, and initiating a phase reverse switch, by using remote circuits from a set of remote control technologies consisting essentially of wireless technologies, software based graphical user interface control panel selection, handheld remote control circuit, a smart phone or smart tablet touch based remote control app, voice command, and automated software based process selection.

8. A system for synthesizing 3D panoramic array of multi-view spatial three-dimensional viewpoints for an autostereoscopic spatial display from a single two-dimensional monocular source digital video media signal comprising:
a processor;
a memory;
a wireless communications component;
a set of software instructions in the form of logic circuit stored in memory for enabling the circuit, under control of the processor;
at least one buffer and electronic logic circuit for storing digital video image frames from the single two-dimensional monocular source digital video media signal sequentially into a digital buffer memory frames;
an electronic logic circuit for temporally copying the source frame sequence to a storage buffer, altering the copy frame through the addition of frames from an incrementally progressive moving subset into the copy frame sequence, the moving subset with pre-selected constant maximum size M, incrementally dropping the head subset member and adding the next consecutive tail member for each incremental subset copy cycle from the source frame sequence;
an electronic logic circuit for vertical-interleaving a multi-view frame from M sequential temporal frames, copying one or more columns of pixels from each of the M moving subset frames to each multi-view frame starting with copying the first vertical pixel column of each sequential M frame to the multi-view frame positioning the M columns sequentially in the multi-view frame, progressively copying a preset constant Nth vertical pixel column from each of the M frame subset to the multi-view frame until each Nth vertical column from each of the M frame subset frames has been copied and columns sequentially stacked by M sequence order in adjacent vertical columns in the multi-view frame;
an electronic logic circuit for incrementing the M sequential subset start frame by one and synthesizing the next sequential multi-view frame until the frame sequence moving M frame subset exhausts the available temporal source frame sequence, and
a barrier or lenticular screen for displaying the multi-view panoramic array of multi-view digital video image frame sequence for 3D viewing.

9. The system of claim 8 wherein the electronic logic circuit for the moving frame subset maximum size constant M is programmable logic thread alterable on the fly from constant M value equal to four through nine, which extends from four to nine views respectively allowing for four to nine ordered stereoscopic pairs respectively and as many resulting horizontal viewing zones.

10. The system of claim 8 further comprising logic for altering the frame sequence order by programmatically adding one or more skip frames after each source frame copy to the temporal buffer frame sequence to adjust for stereoscopic pair disparity developed from objects moving across the frame.

11. The system of claim 8 further comprising logic for 3D viewing embedded into and displayed on a 3D autostereoscopic display circuit chosen from a group of 3D autostereoscopic display systems consisting essentially of a TV display system, desktop display system, laptop display system, PDA display system, smart mobile application software system, smart phone display system, handheld tablet display system, projection based display system, 3D enabled PC display system, 3D podcast display system, a set-top box display system, media hub or media server display system, Apple® TV app, Comcast® display system, and head mounted display with a head orientation tracking multi-view look-around capability system.

12. A system for synthesizing 3D panoramic array of multi-view spatial three-dimensional viewpoints using a machine vision motion adaptation switch through detection of the relative direction of objects in the multi-view array further comprising:
a processor;
a memory;
a wireless component;
a plurality of software instructions in the form of logic circuit stored in memory for enabling the circuit, under control of the processors comprising:
a first logic circuit for reading in single two-dimensional monocular digital video signal frame source;
a second logic circuit providing two horizontal side by side adjustable width vertical stripe segment digital frame masks with adjustable separation distance in each two consecutive frames,
a third logic circuit comparing the masked pixel patterns of the source frame strips to determine the relative left or right direction of a pattern of the relative direction of objects in the frame, left to right or right to left;
a fourth logic circuit triggering a phase reverse switch upon determining a pattern direction reversal; and
a multi-view panoramic array of multi-view digital video image frame sequence for 3D viewing on a barrier or lenticular screen display automatically maintaining the stereo pairs of the right frame and left frame views of any viewing zone within the multi-view array in phase with the start-point of the converted synthetic 3D stereoscopic video display results.

13. A system for adjusting disparity or parallax of synthetic 3D stereoscopic multi-view stereo compression space in a synthesized 3D panoramic array of multi-view spatial three-dimensional viewpoints further comprising:
a processor;
a memory;
a wireless communications component;
a plurality of software instructions in the form of logic circuit stored in memory for enabling the circuit, under control of the processor;
a first logic circuit for storing digital video image frames from the single two-dimensional monocular source digital video media signal sequentially into a digital buffer memory frame sequence;
a second logic circuit for creating a sequence of 3D stereoscopic interleaved column multi-view frames with N view pairs;
a third logic circuit for reserving margins of one or more vertical pixel columns on the left and equal number of vertical pixel columns on the right edges of the interleaved video 3D stereoscopic multi-view frame, shifting the horizontal parallax between each alternating frame in the multi-view format sequence from positive parallax to negative parallax by shifting the number of columns for the start frame;
a fourth logic circuit for shifting the start frame column from left to right on demand by a user selectable interface circuit programmable moving the reserved columns midway into the reserved column margin for positive parallax leaving the center column as the center plane of convergence and the remaining columns for negative parallax within a safe area in the frame buffer width calculated by subtracting the frame horizontal resolution of the interleaved frame from one side of reserved margin; and
a fifth logic circuit circuit for user selection on demand programmably altering the interleaving frame buffer shifting the safe area into and out of the reserved margin vertical pixel columns controlling the parallax of the multi-view frames into and out of the display screen respectively, for multi-view digital video image frame sequence 3D viewing on a barrier or lenticular screen display.

14. A system for customizing the user experience in synthesized 3D panoramic array of multi-view spatial three-dimensional viewpoints rendering comprising:
a processor;
a memory;
a wireless communications component;
a barrier or lenticular display;
a plurality of software instructions in the form of logic circuit stored in memory for enabling the circuit, under control of the processor:
a first logic circuit with reprogrammable parameters in the multi-view digital video image frame process implementable remotely or wirelessly by a group of 3D viewing functions consisting essentially of 3D default settings, 2D or 3D selection, 3D test registration pattern, altering the number of multi-views per frame, and initiating a phase reverse switch; and
a remote control module adapted for implementing remote circuits from a set of remote control technologies consisting essentially of wireless technologies, software based graphical user interface control panel selection, handheld remote control circuit, a smart phone or smart tablet touch based remote control app, voice command, and automated software based process selection, whereby the remote control technology is used to manipulate the 3D viewing parameters on user command for subjective customizable viewing of synthesized 3D panoramic array of multi-view spatial three-dimensional viewpoints on a barrier or lenticular display.

15. A computer program residing on a tangible computer-readable media, the computer program for synthesizing 3D panoramic array of multi-view spatial three-dimensional viewpoints for an autostereoscopic spatial display from a single two-dimensional monocular source digital video media signal comprising:
a. storing digital video image frames from the single two-dimensional monocular source digital video media signal sequentially into a digital buffer memory frames;
b. temporally copying the source frame sequence to a storage buffer, altering the copy frame through the addition of frames from an incrementally progressive moving subset into the copy frame sequence, the moving subset with pre-selected constant maximum size M, incrementally dropping the head subset member and adding the next consecutive tail member for each incremental subset copy cycle from the source frame sequence;
c. vertical-interleaving a multi-view frame from M sequential temporal frames, copying one or more columns of pixels from each of the M moving subset frames to each multi-view frame starting with copying the first vertical pixel column of each sequential M frame to the multi-view frame positioning the M columns sequentially in the multi-view frame, progressively copying a preset constant Nth vertical pixel column from each of the M frame subset to the multi-view frame until each Nth vertical column from each of the M frame subset frames has been copied and columns sequentially stacked by M sequence order in adjacent vertical columns in the multi-view frame; and
d. incrementing the M sequential subset start frame by one and synthesizing the next sequential multi-view frame until the frame sequence moving M frame subset exhausts the available temporal source frame sequence, thereby creating a multi-view panoramic array of multi-view digital video image frame sequence for 3D viewing on a barrier or lenticular screen display.

16. The computer program of claim 15, wherein the moving frame subset maximum size constant M is programmably changeable on the fly from four through nine, which extends from four to nine views respectively in the same sequence pattern allowing for four to nine ordered stereoscopic pairs respectively and as many resulting horizontal viewing zones.

17. The computer program of claim 15, further comprising the altering the frame sequence order by programmatically adding one or more skip frames after each source frame copy to the temporal buffer frame sequence to adjust for stereoscopic pair disparity developed from objects moving across the frame.

18. The computer program of claim 15, further comprising altering programmable parameters in the multi-view digital video image frame process remotely or wirelessly and hence customize the user 3D experience by a group of 3D viewing functions consisting essentially of 3D default settings, 2D or 3D selection, 3D test registration pattern, altering the number of multi-views per frame, and initiating a phase reverse switch, by using remote circuits from a set of remote control technologies consisting essentially of wireless technologies, software based graphical user interface control panel selection, handheld remote control circuit, a smart phone or smart tablet touch based remote control app, voice command, and automated software based process selection.

19. A computer program residing in a tangible computer-readable medium, for a machine vision motion adaptation switch through detection of the relative direction of objects in synthesized 3D panoramic array of multi-view viewpoints further comprising:
a. reading in single two-dimensional monocular digital video signal frame source;
b. providing two horizontal side by side adjustable width vertical stripe segment digital frame masks with adjustable separation distance in each of two consecutive frames;
c. comparing the masked pixel patterns of the source frame strips to determine the relative left or right direction of a pattern of the relative direction of objects in the frame, left to right or right to left; and
d. triggering a phase reverse switch upon determining a object pattern direction reversal, thereby automatically keeping the stereo pairs or the right frame and left frame views of any viewing zone within the multi-view array in phase with the start-point of the converted synthetic 3D stereoscopic video display results.

20. A computer program residing in a tangible computer-readable medium for adjusting disparity or parallax of synthetic 3D stereoscopic multi-view stereo compression space comprising:
a. storing digital video image frames from the single two-dimensional monocular source digital video media signal sequentially into a digital buffer memory frame sequence;
b. creating a sequence of 3D stereoscopic interleaved column multi-view frames with N view pairs;
c. reserving margins of one or more vertical pixel columns on the left and equal number of vertical pixel columns on the right edges of the interleaved video 3D stereoscopic multi-view frame, shifting the horizontal parallax between each alternating frame in the multi-view format sequence from positive parallax to negative parallax by shifting the number of columns for the start frame; and
d. shifting the start frame column from left to right on demand by a user selectable interface circuit programmably moving the reserved columns midway into the reserved column margin for positive parallax leaving the center column as the center plane of convergence and the remaining columns for negative parallax within a safe area in the frame buffer width calculated by subtracting the frame horizontal resolution of the interleaved frame from one side of reserved margin, whereby user selection on demand programmably changes the interleaving frame buffer shifting the safe area into and out of the reserved margin vertical pixel columns adjusting the parallax of the multi-view frames into and out of the display screen respectively.
